(19) United States
(12) Patent Application Publication
(10) Pub. No.: US 2015/0163639 A1
(43) Pub. Date: Jun. 11, 2015

(54) MOBILE DEVICE DEFINED TRACKING AREA

(71) Applicant: QUALCOMM Incorporated, San Diego, CA (US)

(72) Inventors: Thomas E. Kilpatrick, II, San Diego, CA (US); Olufunmilola Awoniyi-Oteri, San Diego, CA (US); Roy Franklin Quick, JR., San Diego, CA (US)

(21) Appl. No.: 14/621,443

(22) Filed: Feb. 13, 2015

Related U.S. Application Data
(63) Continuation-in-part of application No. 14/279,147, filed on May 15, 2014.
(60) Provisional application No. 61/860,789, filed on Jul. 31, 2013.

(51) Int. Cl. H04W 4/02; H04W 64/00

(52) U.S. Cl. CPC H04W 4/028; H04W 4/027; H04W 64/006

(57) ABSTRACT

Methods, systems, and devices are described for defining a tracking area for a mobile device. The mobile device may determine that it is traveling along a predetermined route based on historical information that includes a repeated sequence of historical events associated with mobility patterns of the mobile device. The mobile device may send an indication to the network that it is traveling along the known route and, therefore, refrain from sending location area update messages as it enters new tracking areas along the route. The network may receive the message and define a tracking area for the mobile device based on the historical information. The network may define the tracking area and send page(s) to the mobile device without receiving location area update reporting messages from the mobile device.

### CROSS-REFERENCE

The present application is a continuation-in-part of U.S. patent application Ser. No. 14/279,147 filed May 15, 2014, entitled “PAGING AREA REDUCTION BASED PREDICTIVE MOBILITY,” which claims priority to U.S. Provisional Patent Application No. 61/860,789, filed Jul. 31, 2013, entitled “PREDICTIVE MOBILITY IN CELLULAR NETWORKS.” The entire disclosure of each of the aforementioned applications is incorporated herein by reference for all purposes.

### BACKGROUND

1. Field of the Disclosure

The present disclosure relates to wireless communication systems, and more specifically to defining a tracking area for a mobile device traveling along a route.

2. Description of Related Art

Wireless communication systems are widely deployed to provide various types of communication content such as voice, video, packet data, messaging, broadcast, and so on. These systems may be multiple-access systems capable of supporting communications with multiple users by sharing the available system resources (e.g., time, frequency, space and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, e.g., long term evolution systems.

Generally, a wireless multiple-access communications system may include a number of base stations, each simultaneously supporting communication for multiple mobile devices. Base stations may communicate with mobile devices on downstream and upstream links. Each base station has a coverage range, which may be referred to as the coverage area of the cell. A cellular network may define one or more tracking areas as paging areas and assign some or all of the cells within the geographic area as a tracking area group. The network typically assigns the cells to the tracking area to provide a level of abstraction regarding the location of the mobile device. Generally, the tracking area group may be assigned to the mobile device which may allow the network to identify one or more cells on which to page the mobile device.

Upon entering a new tracking area, a mobile device may typically send location area update messages to the network. The network responds by assigning the mobile device to the new tracking area and sends pages, when necessary, to the mobile device on the last known cell (e.g., the first cell the mobile device contacts in the new tracking area). If that page is unsuccessful, e.g., the mobile device does not respond, the network sends the page to each cell assigned to the new tracking area. Current implementations, however, do not consider historical mobility patterns of the mobile device and, therefore, may utilize unnecessary messaging as the mobile device enters each new tracking area, thereby increasing overhead messaging for the network and power consumption for the mobile device.

### SUMMARY

The described features generally relate to one or more improved systems, methods, and/or apparatuses for a network entity to define or otherwise identify a tracking area of the mobile device based on knowledge that the mobile device is traveling along a known route. The known route may generally be determined based on a sequence of repeated historical events associated with mobility patterns of the mobile device. The mobile device may determine that it is traveling along a known route and send a message indicating this to the network entity, e.g., a mobility management entity (MME). The network entity may define the tracking area of the mobile device based on the historical information and data conveyed in the indication message from the mobile device, e.g., time the mobile device began the route, average route travel time, etc. Accordingly, the network may determine where the mobile device is along the route at any given instant, to a certain degree of accuracy, and send a page to the mobile device based on the defined tracking area of the mobile device. The mobile device may withhold location area updates as the mobile device enters new tracking areas along to route, e.g., provides for the mobile device to withhold its location area updates while traveling on its route. Accordingly, the mobile device and network may leverage previous mobility patterns of the mobile device to avoid unnecessary messaging, but yet maintain locational awareness of the mobile device.

In a first illustrative set of examples, a method for wireless communication is described. The method may include: determining, by a mobile device, that the mobile device is traveling along a predetermined route based on a sequence of repeated historical events associated with mobility patterns of the mobile device; transmitting a message indicating that the mobile device is traveling along the predetermined route to a network; and withholding a location area update by the mobile device when entering a new tracking area along the predetermined route.

In some aspects, the method may include transmitting information indicative of at least one of: a start time when the mobile device began traveling along the predetermined route, an average travel time associated with the mobile device traveling along the predetermined route, or a travel time deviation associated with the mobile device traveling along the predetermined route. The method may include: determining that the mobile device has traveled at least a predetermined distance outside of the predetermined route; and transmitting information indicative of the mobile device being outside of the predetermined route to the network. Determining that the mobile device is outside of the predetermined route may include determining that the mobile device is in communication range with a cell in a tracking area other than tracking areas along the predetermined route.

In some aspects, the method may include: determining that the mobile device has reached a destination location of the predetermined route; and transmitting information indicative of the mobile device reaching the destination location of the predetermined route to the network. The method may include transmitting information indicative of a travel time associated with the mobile device traveling along the predetermined route.

In some aspects, the method may include transmitting information indicative of one or more predetermined routes to the network. The method may include transmitting, for each of the one or more predetermined routes, information indicative of at least one of an average travel time, a travel time deviation, an average start time, or an average arrival time. The method may include receiving a page from a cell in at least one tracking areas along the predetermined route while the mobile device is traveling along the predetermined route.

In a second illustrative set of examples, an apparatus for wireless communication is described. The apparatus may include: a processor; and memory in electronic communication with the processor, the memory embodying instructions. The instructions executable by the processor to: determine, by a mobile device, that the mobile device is traveling along a predetermined route based on a sequence of repeated historical events associated with mobility patterns of the mobile device; transmit a message indicating that the mobile device is traveling along the predetermined route to a network; and withhold a location area update by the mobile device when entering a new tracking area along the predetermined route.

In some aspects, the apparatus may include instructions executable by the processor to transmit information indicative of at least one of: a start time when the mobile device began traveling along the predetermined route, an average travel time associated with the mobile device traveling along the predetermined route, or a travel time deviation associated with the mobile device traveling along the predetermined route. The apparatus may include instructions executable by the processor to: determine that the mobile device has traveled at least a predetermined distance outside of the predetermined route; and transmit information indicative of the mobile device being outside of the predetermined route to the network.

In some aspects, the instructions executable by the processor to determine that the mobile device is outside of the predetermined route are further executable to determine that the mobile device is in communication range with a cell in a tracking area other than tracking areas along the predetermined route. The apparatus may include instructions executable by the processor to: determine that the mobile device has reached a destination location of the predetermined route; and transmit information indicative of the mobile device reaching the destination location of the predetermined route to the network.

In some aspects, the apparatus may include instructions executable by the processor to transmit information indicative of a travel time associated with the mobile device traveling along the predetermined route. The apparatus may include instructions executable by the processor to transmit information indicative of one or more predetermined routes to the network. The apparatus may include instructions executable by the processor to transmit, for each of the one or more predetermined routes, information indicative of at least one of an average travel time, a travel time deviation, an average start time, or an average arrival time. The apparatus may include instructions executable by the processor to receive a page from a cell in at least one tracking areas along the predetermined route while the mobile device is traveling along the predetermined route.

In a third illustrative set of examples, a method for wireless communication is described. The method may include: receiving a message transmitted from a mobile device indicating that the mobile device is traveling along a predetermined route based on a sequence of repeated historical events associated with mobility patterns of the mobile device; determining a tracking area of the mobile device along the predetermined route based on the sequence of repeated historical events associated with the mobility patterns of the mobile device; and sending a page to the mobile device via at least one cell within the determined tracking area.

In some aspects, the method may include determining the tracking area without receiving a location area update message from the mobile device when the mobile device enters a new tracking area along the predetermined route. The method may include: receiving information from the mobile device associated with a start time of when the mobile device began traveling along the predetermined route; and determining the tracking area based at least in part on the start time. The method may include: receiving information from the mobile device associated with an average travel time for the mobile device traveling along the predetermined route; and determining the tracking area based at least in part on the start time and the average travel time.

In some aspects, the method may include: accessing one or more information sources associated with travel conditions along the predetermined route; and determining the tracking area based at least in part on the start time and the travel conditions. The travel conditions may include at least one of a weather condition along the predetermined route, a traffic condition along the predetermined route, or an average travel time associated with beginning to travel along the predetermined route at the start time. The method may include receiving information from the mobile device indicating that the mobile device has arrived at a destination location of the predetermined route.

In a fourth illustrative set of examples, an apparatus for wireless communication is described. The apparatus may include: a processor; and memory in electronic communication with the processor. The memory embodying instructions, the instructions executable by the processor to: receive a message transmitted from a mobile device indicating that the mobile device is traveling along a predetermined route based on a sequence of repeated historical events associated with mobility patterns of the mobile device; determine a tracking area of the mobile device along the predetermined route based on the sequence of repeated historical events associated with the mobility patterns of the mobile device; and send a page to the mobile device via at least one cell within the determined tracking area.

In some aspects, the apparatus may include instructions executable by the processor to determine the tracking area without receiving a location area update message from the mobile device when the mobile device enters a new tracking area along the predetermined route. The apparatus may include instructions executable by the processor to: receive information from the mobile device associated with a start time of when the mobile device began traveling along the predetermined route; and determine the tracking area based at least in part on the start time.

In some aspects, the apparatus may include instructions executable by the processor to: receive information from the mobile device associated with an average travel time for the mobile device traveling along the predetermined route; and determine the tracking area based at least in part on the start time and the average travel time. The apparatus may include instructions executable by the processor to: access one or more information sources associated with travel conditions along the predetermined route; and determine the tracking area based at least in part on the start time and the travel conditions.

The foregoing has outlined rather broadly describing the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a diagram of a wireless communications system, in accordance with various aspects of the present disclosure;

FIG. 2 shows a diagram of an example of device mobility in a wireless communications system, according to one aspect of the principles described herein;

FIG. 3 shows a diagram of another example of device mobility in a wireless communications system, according to one aspect of the principles described herein;

FIG. 4 shows a diagram of an example of communications between devices in a wireless communications system, according to one aspect of the principles described herein;

FIG. 5 shows a diagram of an example of communications between devices in a wireless communications system, according to one aspect of the principles described herein;

FIG. 6 shows a diagram of an example of communications between devices in a wireless communications system, according to one aspect of the principles described herein;

FIG. 7 shows a block diagram of one example of a mobile device, according to one aspect of the principles described herein;

FIG. 8 shows a block diagram of one example of a base station, according to one aspect of the principles described herein;

FIG. 9 shows a flowchart diagram of a method for wireless communications, according to one aspect of the principles described herein;

FIG. 10 shows a flowchart diagram of a method for wireless communications, according to one aspect of the principles described herein; and

FIG. 11 is a flowchart diagram of a method for wireless communications, in accordance with various aspects of the present disclosure.

### DETAILED DESCRIPTION

Methods, systems, and devices are provided that may be used to improve network and/or mobile device performance based on learning and predicting the behavior of a mobile device (e.g., mobile phone, laptop, tablet, etc.) user. A mobile device may record its mobility patterns over a predetermined time to determine when the mobile device is traveling along a known or otherwise predetermined route, e.g., the mobile device may autonomously identify the known or predetermined route based on historical data and, therefore, determine when it is traveling along its route. For example, the mobile device may determine that the user, and by extension the mobile device, travels from home to work each workday along a known route and at a known time, and then returning home along the same or different path. The mobile device may share this historical data with the network entity, e.g., synchronize route information on a periodic basis. The mobile device may determine that the mobile device has begun a known route and signal this information to the network. Signaling information will indicate that the mobile device is on a known or predetermined route which will allow the mobile device to refrain from sending location area updates as it travels into new tracking areas along the route. The mobile device may send a message to the network indicating that it has reached the end of its route or its destination, etc.

As used herein, the term “route” refers to movement of the mobile device as detected by a sequence of events. These events may include reporting or detecting a location of the mobile device, radio events related to a cellular network (e.g., association or disassociation with a particular serving cell or network, reported channel quality, call initiation or termination, roaming, loss of signal, etc.), other radio events (e.g., observation of WiFi networks or Bluetooth devices, etc.), time of day or timer events, or other detectable and replicable events. As used herein, a “predetermined route” refers to a route defined by a sequence or pattern of events that is stored and recognized by the mobile device or cellular network. In certain aspects, a predetermined route may be known based on historical event data collected by the mobile device over time. A predetermined route may be based on a sequence of events that are repeated, to at least some degree, with regular patterns so as to be predictable, e.g., a sequence of physical location events, a sequence of wireless communication related events, a sequence of environmental events, etc. While some predetermined routes may include the same start location (e.g., home) or a common set of events, the mobile device may recognize or determine which route the mobile device is on, if any, based the totality of events observed or reported by the mobile device.

On the network side, the network may receive and/or store the historical mobility pattern data of the mobile device from the mobile device, e.g., data associated with known route(s) and the like. The network may receive the message from the mobile device indicating that the mobile device is traveling along a known route (the specific route being taken) and a time that the mobile device started the route, e.g., a timestamp of when the mobile device sends the message to the network. The network may therefore know that the mobile device is traveling along the predetermined route and that the route includes certain cells. Accordingly, the network may define a tracking area for the mobile device based on the mobile device traveling along its known route. For example, the network may assign certain cells along the route to a new tracking area for the mobile device, may assign all cells within tracking areas along the route as a mobile device specific tracking area, etc. The network may then send a page to the mobile device traveling along the route via at least one cell in the new tracking area, e.g., to a last known cell the mobile device has communicated with and then to all cells within the new tracking area. The network may also know not to expect location area updates from the mobile device as it travels along the route.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (EUTRA), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description below, however, describes an LTE system for purposes of example, and LTE terminology is used in much of the description below, although the techniques are applicable beyond LTE applications.

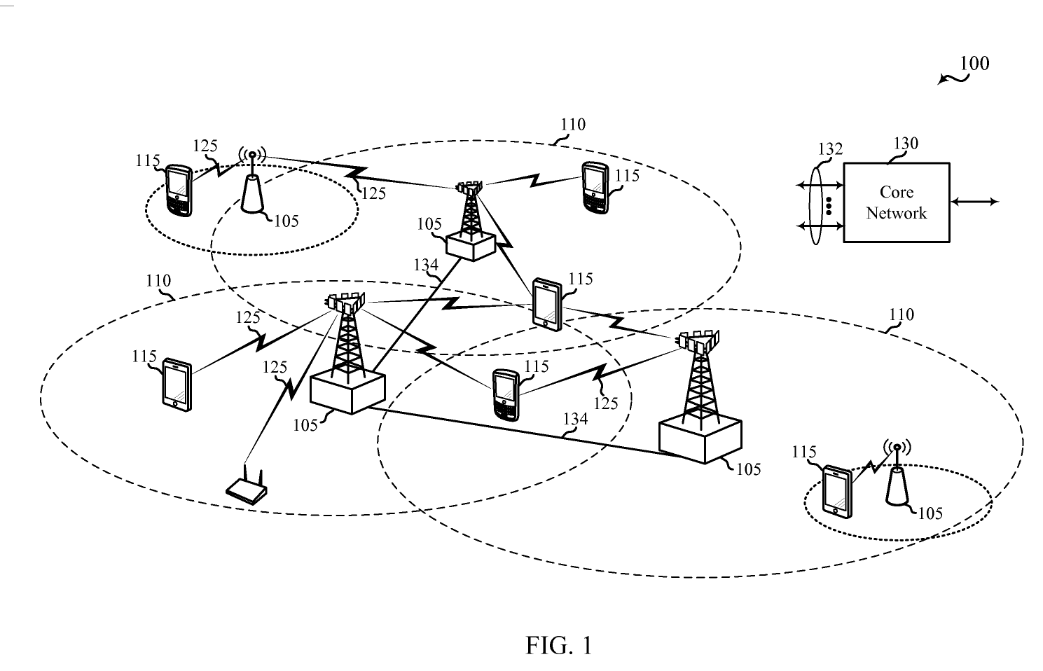

FIG. 1 is a block diagram conceptually illustrating an example of a wireless communications system 100, in accordance with an aspect of the present disclosure. The wireless communications system 100 includes base stations (or cells) 105, mobile devices 115, and a core network 130. The base stations 105 may communicate with the mobile devices 115 under the control of a base station controller (not shown), which may be part of the core network 130 or the base stations 105 in various examples. Base stations 105 may communicate control information and/or user data with the core network 130 through backhaul links 132. In certain examples, the base stations 105 may communicate, either directly or indirectly, with each other over backhaul links 134, which may be wired or wireless communication links. The wireless communications system 100 may support operation on multiple carriers (waveform signals of different frequencies). Multi-carrier transmitters can transmit modulated signals simultaneously on the multiple carriers. For example, each communication link 125 may be a multi-carrier signal modulated according to the various radio technologies described above. Each modulated signal may be sent on a different carrier and may carry control information (e.g., reference signals, control channels, etc.), overhead information, data, etc.

The base stations 105 may wirelessly communicate with the mobile devices 115 via one or more base station antennas. Each of the base stations 105 sites may provide communication coverage for a respective coverage area 110. In some examples, base stations 105 may be referred to as base transceiver stations, radio base stations, access points, radio transceivers, basic service sets (BSSs), extended service sets (ESSs), NodeBs, eNodeBs, Home NodeBs, Home eNodeBs, or some other suitable terminology. The coverage area 110 for a base station may be divided into sectors making up only a portion of the coverage area (not shown). The wireless communications system 100 may include base stations 105 of different types (e.g., macro, micro, and/or pico base stations). There may be overlapping coverage areas for different technologies.

In certain examples, the wireless communications system 100 is an LTE/LTE-A network communication system. In LTE/LTE-A network communication systems, the term evolved Node B (eNodeB) may be generally used to describe the base stations 105. The wireless communications system 100 may be a Heterogeneous LTE/LTE-A network in which different types of eNodeBs provide coverage for various geographical regions. For example, each eNodeB may provide communication coverage for a macro cell, a pico cell, a femto cell, and/or other types of cell. A macro cell generally covers a relatively large coverage area (e.g., several kilometers in radius) and may allow unrestricted access by mobile devices 115 with service subscriptions with the network provider. A pico cell generally covers a relatively smaller coverage area (e.g., buildings) and may allow unrestricted access by mobile devices 115 with service subscriptions with the network provider. A femto cell generally covers a relatively small coverage area (e.g., a home) and, in addition to unrestricted access, may also provide restricted access by mobile devices 115 having an association with the femto cell (e.g., mobile devices 115 in a closed subscriber group (CSG), mobile devices 115 for users in the home, and the like). In such examples, a base station 105 for a macro cell may be referred to as a macro eNodeB, a base station 105 for a pico cell may be referred to as a pico eNodeB, and a base station 105 for a femto cell may be referred to as a femto eNodeB or a home eNodeB. A base station 105 may support one or multiple (e.g., two, three, four, and the like) cells.

The core network 130 may communicate with the base stations 105 via a backhaul link 132 (e.g., S1 interface, etc.). The base stations 105 may also communicate with one another, e.g., directly or indirectly via backhaul links 134 (e.g., X2 interface, etc.) and/or via backhaul links 132 (e.g., through core network 130). The wireless communications system 100 may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from different base stations 105 may not be aligned in time. The techniques described herein may be used for either synchronous or asynchronous operations.

The mobile devices 115 may be dispersed throughout the wireless communications system 100, and each mobile device 115 may be stationary or mobile. A mobile device 115 may also be referred to by those skilled in the art as a user equipment (UE), mobile station, a subscriber station, a mobile unit, a subscriber unit, a wireless unit, a remote unit, a wireless communications device, a remote device, a mobile subscriber station, an access terminal, a mobile terminal, a wireless terminal, a remote terminal, a handset, a user agent, a mobile client, a client, or some other suitable terminology. A mobile device 115 may be a cellular phone, a personal digital assistant (PDA), a wireless modem, a wireless communication device, a handheld device, a tablet computer, a laptop computer, a cordless phone, a wireless local loop (WLL) station, or the like.

The communication links 125 shown in the wireless communications system 100 may include uplink (UL) transmissions from a mobile device 115 to a base station 105, and/or downlink (DL) transmissions, from a base station 105 to a mobile device 115. The downlink transmissions may also be called forward link transmissions while the uplink transmissions may also be called reverse link transmissions.

Mobile device 115 users typically have predictable behavior, often doing the same things or going to the same places at about the same time each day. One example is the travel pattern and schedule of a mobile device 115 user going to and from work. The user may typically leave home at a certain time, travel certain roads to get to work, stay at work until it is time to go back home using the same roads as before, and then repeat more or less the same routine the next day. Because the movements of mobile device 115 user in such a scenario can be foreseeable, it may be possible to predict with a high degree of confidence which cells are used by the mobile device 115 at particular times when going to work, when returning home at the end of the day, or even when taking a lunch break. This prediction may be based on previous measurements, cell reselections (e.g., when the mobile device 115 is in idle mode), and/or handovers, which were performed by the mobile device 115 during the user's commute. Moreover, the use of predictive behavior may also apply to other devices such as laptops, tablets, pads, machine-to-machine (M2M) devices, and the like.

Historical information defining predictable behavior may refer to data taken over a long enough time to show at least two instances of a repeated sequence of mobile device environmental events. As used in this context, an event refers to a detectable condition occurring at a mobile device, a base station, a network entity, or the like, which singularly or in combination with other events triggers an action. Example environmental events may include one or more radio frequency (RF) events, such as channel measurements of particular cells, connection to a specific wireless fidelity (Wi-Fi) access point, and the like. Additionally or alternatively, environmental events may include one or more user events. Examples of user events may include, but are not limited to, initiation or acceptance of calls, sending or receiving data, usage of a particular application, and the like. In still other examples, environmental events may include one or more location events. Example location events may include, but are not limited to arriving at a location, leaving a location, a speed of movement, an amount of time spent at a location, and the like. In additional or alternative examples, environmental events may include one or more time events. Examples of time events may include, but are not limited to, start or end of work hours, etc. Repeated sequences of environmental events may be taken as sequences with enough correlation and regularity to ensure the mobile device is following a similar path with the same use requirements. The sequences may not necessarily be identical, but may occur frequently enough and with sufficient similarity to provide confidence of the predictive mobility of the mobile device.

The ability to learn and predict the behavior of the mobile device 115 user may be used to define a tracking area for the mobile device 115 as the mobile device 115 travels along a known or predetermined route. For example, if the historical information associated with the mobility patterns of the mobile device 115 indicate that the mobile device 115 has previously traveled through particular tracking areas along a known route, the mobile device 115 may know when it has started traveling along the known route and send one or more messages, via a serving base station (or cell) 105, to a network entity indicating that it is traveling the known route. The mobile device 115 may then refrain or withhold location area update messages as it travels through different tracking areas along the known route.

The network entity may receive the message(s) from the mobile device 115 indicating that the mobile device 115 is traveling along the known path. The network entity may, alone or in coordination with other entities, define a tracking area for the mobile device 115. The network may define the tracking area without receiving the location area update messages from the mobile device 115 traveling along the route. The network entity may then send a page to the mobile device 115 via a cell in the defined tracking area.

The mobile device 115 and the network entity utilizing the historical information to define tracking areas for the mobile device 115 without the customary location area update messages may cause a reduction in overhead signaling messages as well as conserving time frequency resources at the serving base station 105. In dense urban areas, for example, where large numbers of small cells and/or Wi-Fi hot spots are deployed, predicting the mobile device 115 mobility (e.g., pattern and schedule) may have an impact on the performance of both the network and the mobile device 115.

Although the described techniques refer to a tracking area and/or location area update terminology, it is to be understood that, in some aspects, the tracking area described in the present disclosure may be coextensive (and used interchangeably) with one or more paging groups or tracking groups. In addition, the terms location area update and tracking area updates may be interchangeable.

Generally, predictive mobility in wireless networks may be used to alleviate network signaling demands and/or to allocate networking resources more effectively.

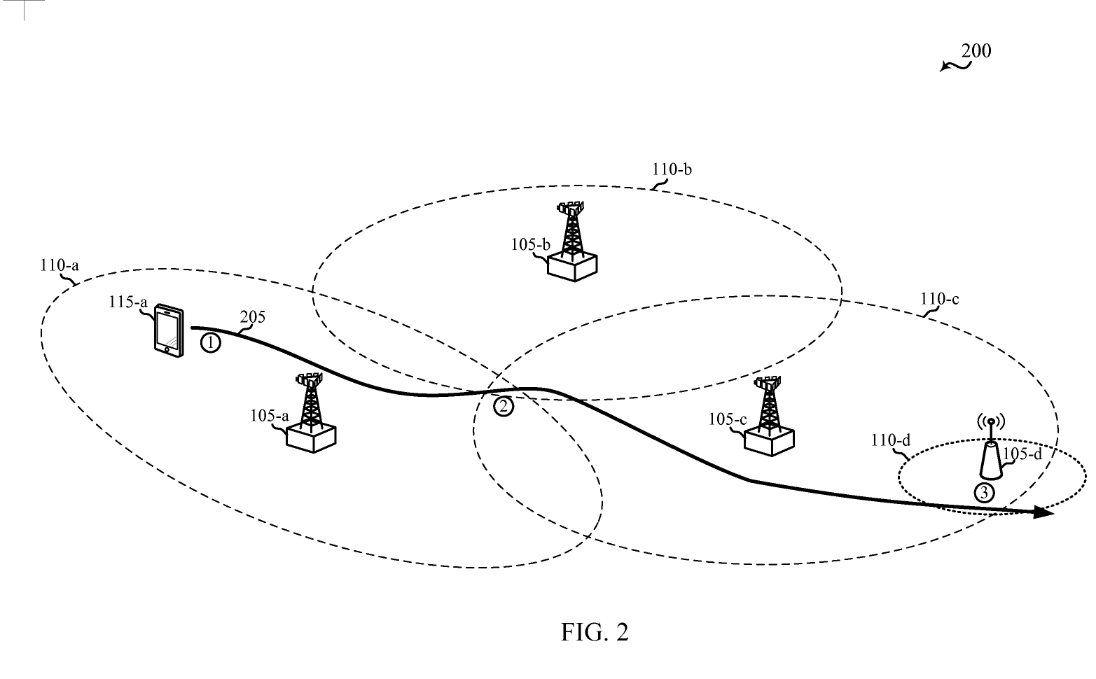

FIG. 2 shows a diagram of a simplified example of device mobility in a wireless communications system 200, according to one aspect of the principles described herein. In the wireless communications system 200 of FIG. 2, a mobile device 115-a travels along a route 205 through the coverage areas 110-a, 110-b, 110-c, 110-d of a first base station 105-a, a second base station 105-b, a third base station 105-c, and a fourth base station 105-d, respectively. The mobile device 115-a may be an example of one or more of the mobile devices 115 of FIG. 1. Similarly, the base stations 105 of FIG. 2 may be examples of one or more of the base stations 105 of FIG. 1.

Each base station 105 may represent an actual or potential serving cell for the mobile device 115-a. In the present example, the mobile device 115-a may begin at position 1 with the first base station 105-a as the serving cell, then move through the coverage area 110-a of the first base station 105-a to position 2. At position 2, the mobile device 115-a may be located at the outer reaches of the coverage area 110-a of the first base station 105-a and enter an intersection of the coverage areas 110-a, 110-b, 110-c of the first, second, and third base stations 105-a, 105-b, 105-c. At position 2, the mobile device 115-a may report a signal strength measurement of the first base station 105-a, the current serving cell, to the first base station 105-a. Accordingly, the mobile device 115-a may perform a handover procedure to connect to base station 105-b or 105-c. Similar procedures may be followed with other base stations 105 along route 205.

In conventional systems, one or more of the base stations 105-a, 105-b, and/or 105-c may be assigned to different tracking areas. As the mobile device 115-a enters different coverage areas 110-a, 110-b, 110-c, while in an idle mode, the mobile device 115-a may send location area update messages to report that it has entered into a new tracking area. The base station 105 receiving the location area update message informs the MME that the mobile device 115-a is in the new tracking area. The MME then assigns the mobile device 115-a to the new tracking area and, if a page arrives for the mobile device 115-a, sends the page via at least one cell in the tracking area.

The above described scenarios may provide an example of environmental events that may be recorded and tracked as historical information of mobility patterns of the mobile device 115-a. Over a period of time, the mobility pattern of the mobile device 115-a along the route 205 may be repeated a predetermined number of times to provide a high degree of confidence of which of the base stations 105 and, by extension the associated tracking areas, the mobile device 115-a will pass through. The present description provides methods, systems, and devices that may be used to improve network and/or mobile device 115-a performance based on learning such example environmental events. The use of predictive behavior may involve the mobile device 115-a determining that it is traveling along route 205 based on the historical information associated with mobility patterns of the mobile device 115-a. The historical information may indicate that a sequence of repeated historical events associated with mobility patterns of the mobile device 115-a, in combination with the current state of the mobile device 115-a, is being repeated with a degree of confidence that suggests the mobile device 115-a is traveling route 205.

In the example of FIG. 2, for example, the mobile device 115-a may regularly travel along route 205 at regular intervals, times of day, and at consistent speeds. This behavior may be tracked and stored at the mobile device 115-a, one or more of the base stations 105, etc. The predicted behavior of the mobile device 115-a may be used to modify mobility parameters (e.g., the mobile device 115-a may autonomously or without direction from its serving base station send a message indicating that it is traveling along known route 205). The mobile device 115-a may include in the indication message the time it started along the route 205, an identifier of the route 205, and the like. The mobile device 115-a may then withhold location area update messages as it travels through the coverage areas 110 associated with different tracking areas.

The network entity, e.g., MME, may receive the indication and access information associated with the known routes of the mobile device 115-a from the mobile device 115-a. For example, the MME may access information associated with route 205 and, therefore, know that the mobile device 115-a will be traveling through tracking areas associated with coverage areas 110-a, 110-b, 110-c, etc. Accordingly, the MME may assign or otherwise define a tracking area for the mobile device based on the route 205 information. For example, the MME may define a tracking area that includes each tracking area along the route 205 (e.g., a larger tracking area). In another example, the MME may define a tracking area that includes cells with coverage areas 110 that provide service along route 205. In yet another example, the MME may define a tracking area based on an estimation of where the mobile device 115-a is along the route at any given moment based on the route start time, average travel time, etc. The MME may, in some example, access information associated with traffic patterns along route 205 to determine if congestions, accidents, etc., might delay the progress of the mobile device 115-a along route 205. Accordingly, the MME may define a tracking area for the mobile device 115-a without receiving location area update messages but, instead, based on the historical information associated with previous mobility patterns of the mobile device 115-a.

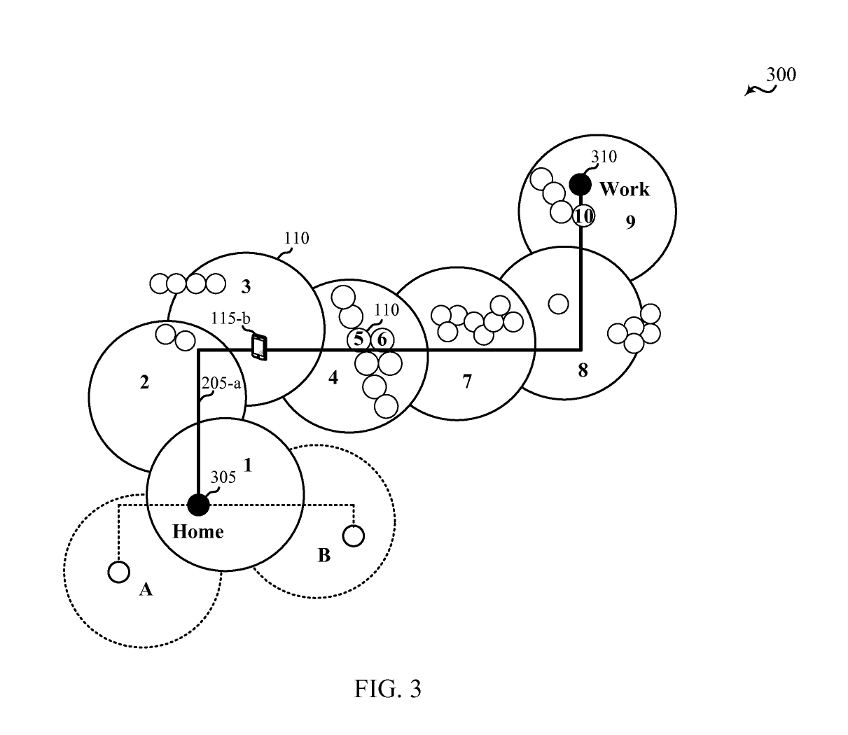

FIG. 3 show a diagram of an example of device mobility in a wireless communications system 300, according to aspects of the principles described herein. Specifically, FIG. 3 illustrates an illustrative route 205-a of a mobile device 115-b between a home location 305 and a work location 310. The route 205-a may traverse the coverage areas 110 of a number of large cells and small cells.

When behavioral information is not considered, the user may travel from the home location 305 to the work location 310 along the depicted route 205-a in a normal manner. For example, cells along the route 205-a may be assigned to tracking areas based on known network management protocols and without consideration of the mobility patterns of the mobile device 115-b, e.g., without considering the repeated historical events associated with the mobility patterns of the mobile device 115-b along the route 205-a, the home location 305, or the work location 310.

In one example of a repeated historical event, after the signal strength drops in cell 1, the mobile device 115-b may find cell 2 the strongest and the network may instruct the mobile device 115-b to hand-off to cell 2. The same process may take place with cells 3, 4, 5, 6, 7, 8, 9, and 10 until the user reaches the work location 310. One or more of the cells along route 205-a may be assigned to a different tracking area by a network entity. Moreover, the mobile device 115-b may traverse clusters of femtocells or other small cells (e.g., cells 5, 6, and 10) having small cell radiuses along the route 205-a, which may result in various other handover events in which the mobile device 115-b is handed over to or from one or more cells. Each handover event may be an example of an environmental event for the mobile device 115-b that may repeated with sufficient regularity and consistency that the mobility patterns of the mobile device 115-b may be predicted to within a high degree of confidence (e.g., >75%, >85%, >95%).

In addition to the handover events, the mobile device 115-b may record and store other environmental events, e.g., how long the mobile device 115-b remains at a given location, what time the mobile device arrives or departs from a location, etc. In conventional systems, the mobile device 115-b may report entering a new tracking area along route 205-a to a first cell the mobile device 115-b communicates with in the new tracking area. In the case where historical information indicates the mobile device 115-b traverses the same tracking areas each trip along route 205-a, location area update message reporting may consume valuable time frequency resources of the serving base station and mobile device 115-b, valuable power resources of the mobile device 115-b, and the like. To overcome these inefficiencies, predictive behavior of the mobile device 115-b may be leveraged in a number of ways.

According to a first approach, a predictive algorithm application may reside on the mobile device 115-b. Mobile device profile information (i.e., based on collected historical information associated with mobility patterns of the mobile device) may be stored by the mobile device 115-b for use by the predictive algorithm application. Over a certain learning period (e.g., twenty days), enough environmental event information (e.g., location, time, speed, cell measurements, etc.) may be collected by the mobile device 115-b to predict with a high degree of confidence where the mobile device 115-b will be on a certain day and time, when the mobile device is traveling along a known route, and the like. Additionally, a network entity (e.g., MME) may collect, store, or otherwise share the profile information of the mobile device 115-b, and the predictive algorithm application of the mobile device 115-b may communicate with the network entity to access the mobile device profile information.

The predictive algorithm application may identify with a high degree of confidence (e.g., >90%) that the mobile device 115-b is moving along a known route 205-a from the home location 305 to the work location 310. The mobile device 115-b may transmit a message (e.g., a radio resource connection (RRC) message, a random access channel message, etc.) to the serving cell having one or more information elements indicating that it is traveling along known route 205-a, for example, based on this historical information associated with multiple trips along route 205-a. The mobile device 115-b may continue along route 205-a and withhold or omit location area update messages as it enters new tracking areas. For example, the mobile device 115-b may communicate with a cell assigned to a different tracking area than the tracking area of the current serving cell. Based on sending the message indicating that it is traveling along route 205-a, however, the mobile device 115-b may omit the traditional location area update messages associated with entering different tracking areas along route 205-a.

In some aspects, the mobile device 115-b may synchronize route information with the network entity. For example, the mobile device 115-b may record and store the repeated historical events, as described above, and determine that it has one or more known routes that it travels with sufficient regularity. The mobile device 115-b may communicate with a network entity to provide information associated with each known route. In certain aspects, route information may include a route identifier, a start location, a destination location, an average start time, an average travel time, an average travel time, and the like. The mobile device 115-b may share the route information with the network entity once, periodically, etc. As one example, the mobile device 115-b may synchronize its known route information with the network entity during idle periods when connected to a power source (e.g., overnight).

In some aspects, the predictive algorithm application may determine that the mobile device 115-b is traveling along a known route, e.g., route 205-a, and send a message via the current serving cell to the network entity. The message may include information indicative of the route identifier, the time the mobile device 115-b started along the route 205-a, etc. In some example, the time of the message transmission may convey the route travel start time. In some example, the mobile device 115-b may communicate the message utilizing one or more information elements associated with RRC messaging. In another example, the mobile device 115-b may utilize one or more information elements associated with a random access procedure (RACH) messaging to convey the route indication. Once the mobile device 115-b sends the message indicating that it is traveling along a known route, it may continue along the route without sending subsequent location area update messages.

In some aspects, the mobile device 115-b may determine that it has deviated from the known route, e.g., traveled a certain distance from the route 205-a. The mobile device 115-b may then send another message to inform the network entity that it has deviated from the route and, therefore, will be reverting to typical location area update reporting. In one example, the mobile device 115-b may send a location area update message to inform the network entity that it has deviated from the known route.

In some aspects, the mobile device 115-b may determine that it has reached the destination location of the route 205-a, e.g., work location 310. Accordingly, the mobile device 115-b may send a message informing the network entity that it has reached the destination location. For example, the mobile device 115-b may send a location area update message to notify the network entity that it has reached the destination location. Other messaging techniques may also be used to let the network entity know the mobile device 115-b has reached the destination location, e.g., the mobile device 115-b may handover and connect to cell 10.

On the network side, the network entity may synchronize the known route information with the mobile device 115-b as described above, e.g., periodically. The network entity may receive the message indicating that the mobile device 115-b is traveling along the known route. For example, the message may include information identifying the route the mobile device is traveling. The network entity may define a tracking area based on the mobile device 115-b traveling along the known route. In some examples, the network entity may define the tracking area to include each tracking area covering the route 205-a. In another example, the network entity may define a tracking area from the available tracking areas along the route 205-a based on where the mobile device 115-b is along the route 205-a.

In yet another example, the network entity may define a tracking area that is particular to the mobile device. For instance, the network entity may define a tracking area that includes each cell providing coverage along the route 205-a.

In certain aspects, the network entity may track the progress of the mobile device 115-b along the route 205-a. For example, the network may determine the route travel time, route length, etc., and, based on the time the mobile device 115-b began traveling along the route 205-a, determine, at least to a certain degree of confidence, where the mobile device 115-b is along the route 205-a. Accordingly, the network entity may define the tracking area for the mobile device 115-b as it travels along the route 205-a that may include a rolling cell count. For instance the network entity may include cells within a certain distance from the mobile device 115-b, e.g., cells ahead and cells behind the mobile device 115-b. As the mobile device 115-b progresses along the route 205-a, the network entity may update the cells in the tracking area to add cells in the path of the mobile device 115-b and to remove cells behind the mobile device 115-b.

In certain aspects, the network entity may access additional information to determine the location of the mobile device 115-b along the route 205-a. For instance, the network entity may access information indicative of road conditions along the route 205-a, e.g., congestion, accidents, constructions, etc., to determine any time offsets for the mobile device 115-b. The network entity may determine that the road conditions may delay the mobile device 115-b as it travels along the route 205-a and adjust the defined tracking area accordingly. The network entity may also access weather information to determine any impact on the travel time for the mobile device 115-b along the route 205-a. Accordingly, the network entity may refine the estimated location of the mobile device 115-b along route 205-a based on a wide variety of considerations to improve the tracking area defined for the mobile device 115-b, without receiving location area updates from the mobile device 115-b as it travels along route 205-a.

In some aspects, the network entity may receive messages from the mobile device 115-b indicating that it has deviated from the known route. Accordingly, the network entity may determine that more traditional tracking area assignments may be more applicable to the mobile device 115-b. Additionally or alternatively, the network entity may receive messages from the mobile device 115-b indicating that it has reached a destination location of the route 205-a, e.g., work location 310.

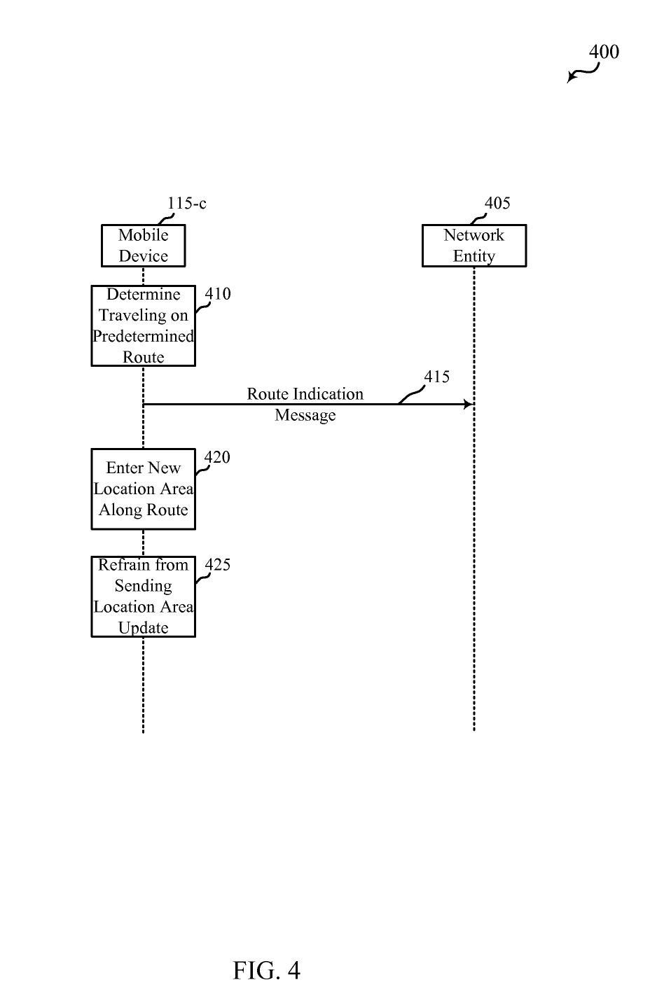

FIG. 4 shows a diagram of an example of communications between devices in a wireless communications system 400, according to one aspect of the principles described herein. The wireless communications system 400 of the present example includes a mobile device 115-c and a network entity 405. In certain embodiments, the historical information related to known routes of the mobile device 115-c may be stored on, and synchronized between the mobile device 115-c and the network entity 405. The wireless communications system 400 may be an example of one or more of the wireless communications systems 100, 200, 300 described above with respect to the previous Figures. The mobile device 115-c may be an example of a mobile device 115 described above with respect to the previous figures. The network entity 405 may be an example of the core network 130 describe above with respect to the previous figures and may, in some examples, be a MME.

The mobile device 115-c may determine that it is traveling along a known or predetermined route at block 410. Generally, the mobile device 115-c may determine that it is traveling along the known route autonomously and based on historical information associated with a sequence of repeated historical events associated with the mobility patterns of the mobile device 115-c. In one example, a predictive algorithm application may be executed by the mobile device 115-c to determine that the mobile device 115-c is traveling along the known route. The predictive algorithm application of the mobile device 115-c may store and/or retrieve historical information associated with mobility patterns of the mobile device 115-c as well as additional mobility state information of the mobile device, e.g., the current time, that the mobile device 115-c is traveling, etc., to determine that the mobile device 115-c is traveling along the known route.

At block 415, the mobile device 115-c may communicate information indicating that it is traveling along the known route to the network entity 405. For example, the mobile device 115-c may send a message to a serving cell that is conveyed via a backhaul link to the network entity 405. The message indicating that the mobile device is traveling along the known route may include route identifying information, travel start time, etc. In some aspects, the mobile device 115-c may re-purpose one or more information elements of an RRC message, a RACH message, etc., to convey the indication of the mobile device 115-c traveling along the known route. At block 420, the mobile device 115-c may enter a new location area (e.g., a new tracking area) along the known route. For example, the mobile device 115-c may receive one or more reference symbols from a cell that is assigned to a different tracking area. At block 425, the mobile device 115-c may refrain from sending a location area update message indicating that it has entered the new tracking area. For example, as the mobile device 115-c enters new tracking areas along the known route, the mobile device 115-c may determine that the new location area is associated with the known route, that it has sent the message indicating that it is traveling along the route, and, therefore, determine that no location area update message is to be sent.

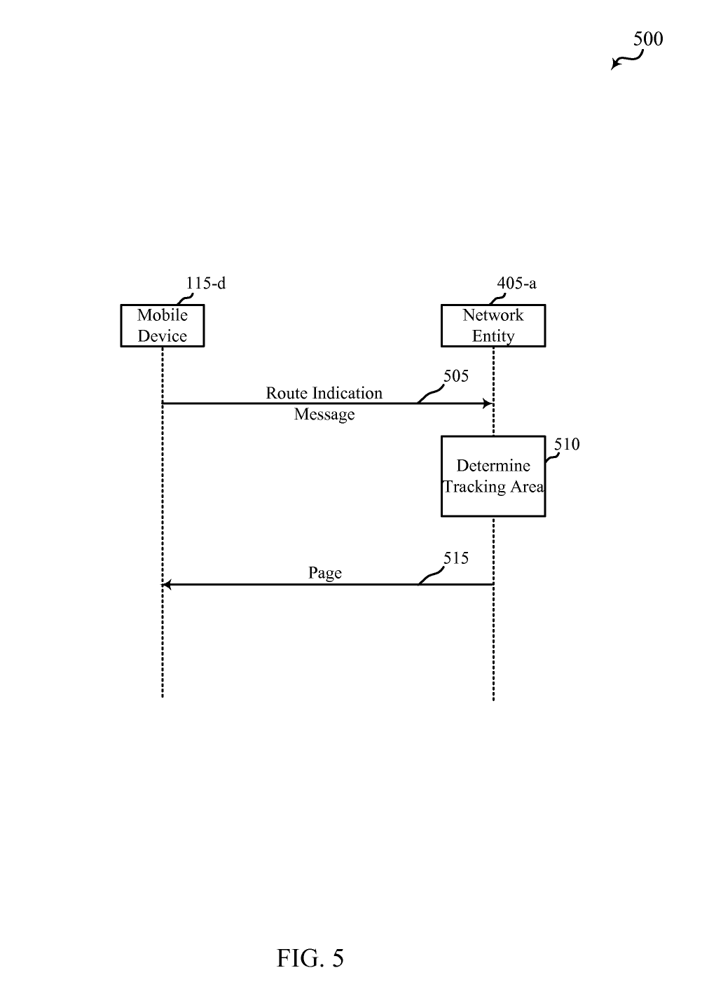

FIG. 5 shows a diagram of an example of communications between devices in a wireless communications system 500, according to one aspect of the principles described herein. The wireless communications system 500 of the present example includes a mobile device 115-d and a network entity 405-a. In certain embodiments, the historical information related to known routes of the mobile device 115-d may be stored on, and synchronized between the mobile device 115-d and the network entity 405-a. The wireless communications system 500 may be an example of one or more of the wireless communications systems 100, 200, 300, 400 described above with respect to the previous Figures. The mobile device 115-d may be an example of a mobile device 115 described above with respect to the previous figures. The network entity 405-a may be an example of the core network 130 describe above with respect to the previous figures and may, in some examples, be a MME.

At block 505, the mobile device 115-d may communicate information indicating that it is traveling along the known route to the network entity 405-a. For example, the mobile device 115-d may send a message to a serving cell that is conveyed via a backhaul link to the network entity 405-a. The message indicating that the mobile device 115-d is traveling along the known route may include route identifying information, travel start time, etc. In some aspects, the mobile device 115-d may re-purpose one or more information elements of an RRC message, a RACH message, etc., to convey the indication of the mobile device 115-d traveling along the known route.

At block 510, the network entity 405-a may determine a tracking area for the mobile device 115-d. The network entity 405-a may define a tracking area for the mobile device 115-d based on the mobile device 115-d traveling along the known route. In some examples, the network entity 405-a may define a tracking area that includes one or more tracking areas along the known route, a custom tracking area for the mobile device 115-d that includes cells providing coverage for the known route, a custom tracking area for the mobile device 115-d that includes a rolling cell count based on where along the known route the mobile device 115-d is, etc. The network entity 405-a may define the tracking area for the mobile device 115-d without receiving location area update messages from the mobile device 115-d as it travels along the known route. At block 515, the network entity 405-a may send a page via at least one cell within the tracking area. Accordingly, the network entity may leverage the historical information to ensure the mobile device 115-d can be paged while traveling along the known route but without requiring traditional location area update reporting messages from the mobile device 115-d.

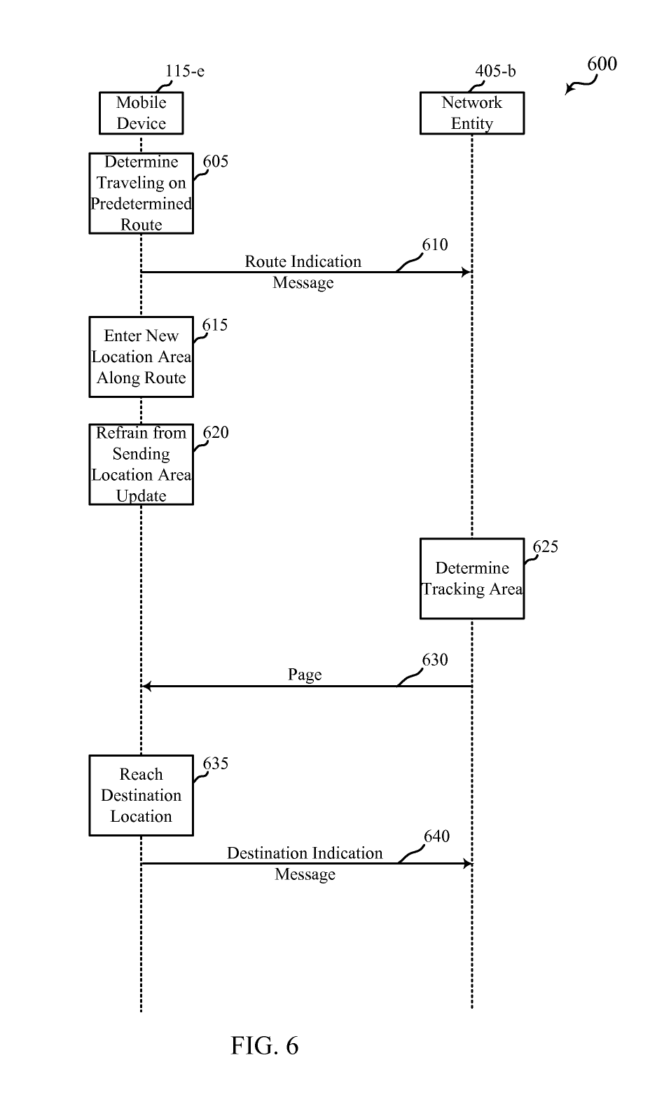

FIG. 6 shows a diagram of an example of communications between devices in a wireless communications system 600, according to one aspect of the principles described herein. The wireless communications system 600 of the present example includes a mobile device 115-e and a network entity 405-b. In certain embodiments, the historical information related to known routes of the mobile device 115-e may be stored on, and synchronized between the mobile device 115-e and the network entity 405-b. The wireless communications system 600 may be an example of one or more of the wireless communications systems 100, 200, 300 described above with respect to the previous figures. The mobile device 115-e may be an example of a mobile device 115 described above with respect to the previous figures. The network entity 405-b may be an example of the core network 130 describe above with respect to the previous figures and may, in some examples, be a MME.

At block 605, the mobile device 115-e may determine that it is traveling along a known or predetermined route. Generally, the mobile device 115-e may determine that it is traveling along the known route autonomously and based on historical information associated with a sequence of repeated historical events associated with the mobility patterns of the mobile device 115-e. In one example, a predictive algorithm application may be executed by the mobile device 115-e to determine that the mobile device 115-e is traveling along the known route. The predictive algorithm application of the mobile device 115-e may store and/or retrieve historical information associated with mobility patterns of the mobile device 115-e as well as additional mobility state information of the mobile device, e.g., the current time, that the mobile device 115-e is traveling, etc., to determine that the mobile device 115-e is traveling along the known route.

At block 610, the mobile device 115-e may communicate information indicating that it is traveling along the known route to the network entity 405-b. For example, the mobile device 115-e may transmit a route indication message to a serving cell that is conveyed via a backhaul link to the network entity 405-b. The route indication message may indicate that the mobile device is traveling along the known route may include route identifying information, travel start time, etc. In some aspects, the mobile device 115-e may re-purpose one or more information elements of an RRC message, a RACH message, etc., to convey the indication of the mobile device 115-e traveling along the known route. At block 615, the mobile device 115-e may enter a new location area (e.g., a new tracking area) along the known route. For example, the mobile device 115-e may receive one or more reference symbols from a cell that is assigned to a different tracking area. At block 620, the mobile device 115-e may refrain from sending a location area update message indicating that it has entered the new tracking area. For example, as the mobile device 115-e enters new tracking areas along the known route, the mobile device 115-e may determine that the new location area is associated with the known route, that it has sent the message indicating that it is traveling along the route, and, therefore, determine that no location area update message is to be sent.

At block 625, the network entity 405-b may determine a tracking area for the mobile device 115-e. The network entity 405-b may define a tracking area for the mobile device 115-e based on the mobile device 115-e sending the message at 610 indicating that it is traveling along the known route. In some examples, the network entity 405-b may define a tracking area that includes one or more tracking areas along the known route, a custom tracking area for the mobile device 115-e that includes cells providing coverage for the known route, a custom tracking area for the mobile device 115-e that includes a rolling cell count based on where along the known route the mobile device 115-e is, etc. The network entity 405-b may define the tracking area for the mobile device 115-e without receiving location area update messages from the mobile device 115-e as it travels along the known route. At block 630, the network entity 405-b may send a page via at least one cell within the tracking area.

At block 635, the mobile device 115-e may determine that it has reached a destination location of the route. For example, the mobile device 115-e may determine that it has reached a work location, a home location, etc. Accordingly, at block 640 the mobile device 115-e may send a message to the network entity 405-b indicating that the mobile device 115-e has reached the destination location.

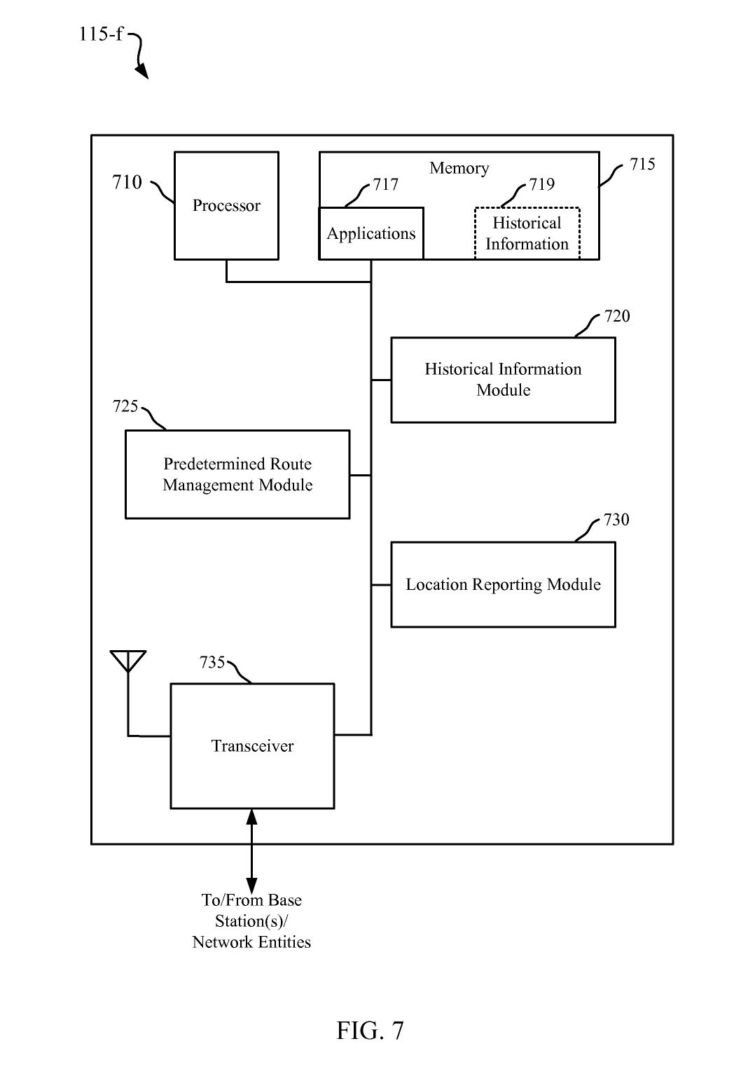

FIG. 7 shows a block diagram of one example of a mobile device 115-f, according to one aspect of the principles described herein. The mobile device 115-f may be an example of one or more of the mobile devices 115 described above with reference to the previous figures. The mobile device 115-f may include a processor 710, a memory 715, a historical information module 720, a predetermined route management module 725, a location reporting module 730, and a transceiver 735. Each of these components may be in communication, directly or indirectly.

The processor 710 may be configured to execute computer-readable program code stored by the memory 715 to implement one or more aspects of the historical information module 720, the predetermined route management module 725, the location reporting module 730, and/or the transceiver 735. The processor 710 may also execute computer-readable program code stored by the memory 715 to implement other applications 717.

The historical information module 720 may be configured to implement aspects of the functionality of one or more of the predictive algorithm applications described above with respect to the previous figures. In certain examples, the historical information module 720 may identify and store (e.g. in historical information 719 of memory 715) historical information associated with mobility patterns of the mobile device 115-h. The historical information may further be identified based on a current location or state of the mobile device 115-f in relation to the historical information 719.

In certain examples, a network entity may also store the historical information provided by the mobile device 115-f. In this case, the historical information module 720 may determine this information based on signaling from the serving cell and/or other network entity. The mobile device 115-f may communicate with the network entity via a serving cell using the transceiver 735 to share and/or retrieve the historical information. In certain examples, the historical information module 720 may communicate with a server (e.g., over transceiver 735) to receive the historical information. Additionally or alternatively, the mobile device 115-f may collect and store the historical information 719 locally in the memory 715 of the mobile device 115-f, as shown in FIG. 7.

The historical information may include information about the mobility patterns of the mobile device 115-f. The mobility patterns may include, for example, a route and a schedule of the mobile device 115-f between a first location and a second location. Additionally or alternatively, the mobility patterns may include a location and a period of time during which the mobile device 115-f remains at the location. Thus, in certain examples, the historical information may include a serving cell history of the mobile device 115-f over a predetermined period of time, as observed and stored by the server, the serving cell, and/or the mobile device 115-f. In some cases, the historical information may define predictable behavior may refer to data taken over a long enough time to show at least two instances of a repeated sequence of a mobile device environmental event, e.g., rolling historical information that covers activities over a predetermined time frame (e.g., a week, a month, etc.). Example environmental events may include one or more radio frequency (RF) events, one or more user events, one or more location events, and/or one or more time events. Repeated sequences of environmental events may be taken as sequences with enough commonality and regularity to ensure the mobile device is following a similar path with the same use requirements. The sequences may not necessarily be identical, but may occur frequently enough and with sufficient similarity to provide confidence of the predictive mobility of the mobile device.

The predetermined route management module 725 may be configured to determine that the mobile device 115-f is traveling along a known route. For example, the predetermined route management module 725 may communicate with the historical information module 720 and, based on its current location and movement, on a current time, etc., determine that the mobile device 115-f is traveling along a known route. The predetermined route management module 725 may identify the route from information associated with multiple routes and provide an output indicating which route the mobile device 115-f is traveling on.

In some aspects, the predetermined route management module 725 may send information to the network entity associated with the known route. For example, the information reported may include, but is not limited to, transmitting information indicative of a start time when the mobile device began traveling along the predetermined route, an average travel time associated with the mobile device traveling along the predetermined route, or a travel time deviation associated with the mobile device traveling along the predetermined route.

The location reporting module 730 may be configured to report the location of the mobile device 115-f to a network entity, for example. In some cases, the location reporting module 730 may determine that the mobile device is traveling along a known route, has reported this situation to the network entity, and therefore refrains from reporting the location of the mobile device 115-f as it enters new tracking areas along the route. In other examples, the location reporting module 730 may determine that the mobile device 115-f has deviated from the known path by traveling a certain distance outside of the route, etc., and therefore may report the location of the mobile device 115-f as it enters new tracking areas.

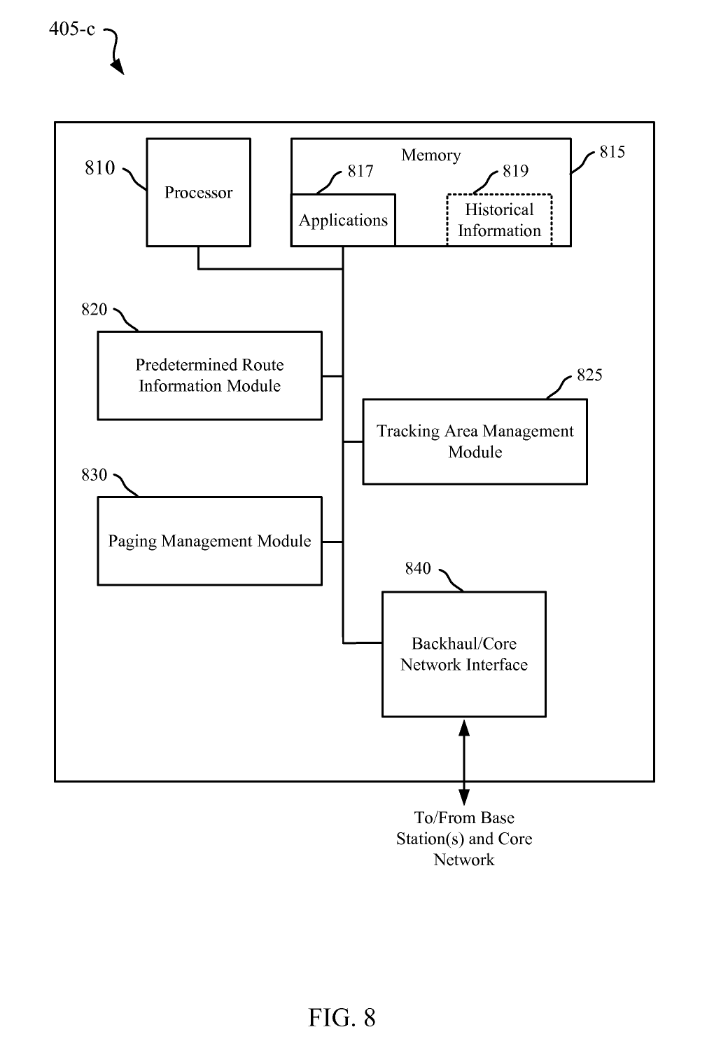

FIG. 8 shows a block diagram of a design of a network entity 405-c, in accordance with an aspect of the present disclosure. The network entity 405-c may be an example of one or more of the core network 130 and/or the network entities 405 described above with respect to FIGS. 1-7. In some examples, the network entity 405-c may be a MME component of the core network 130.

The network entity 405-c may be equipped with a processor 810, a memory 815, storing applications 817, a predetermined route information module 820, a tracking area management module 825, a paging management module 830, and a backhaul/core network interface 840. Each of these components may be in communication, directly or indirectly.

The processor 810 may be configured to execute computer-readable program code stored by the memory 815 to implement one or more aspects of the predetermined route information module 820, the tracking area management module 825, the paging management module 830, and/or the backhaul/core network interface 840. The processor 810 may also execute computer-readable program code stored by the memory 815 to implement other applications 817.

In some cases, the network entity 405-c may communicate with a network through the backhaul/core network interface 840 to receive information from the base stations 105 and/or to send information to the base stations 105.

The predetermined route information module 820 may be configured to receive, determine, store, or otherwise access information associated with one or more routes for a mobile device. The predetermined route information module 820 may receive the message from the mobile device indicating that it is traveling along a predetermined or known route and output information indicative of such to other module(s) of the network entity 405-c. The message indicating that the mobile device is traveling along the known route may include a start time the mobile device began traveling along the route, an average travel time for the mobile device traveling along the route, etc.

In some aspects, the predetermined route information module 820 may synchronize route information with the mobile device such that the information is known by the network entity 405-c. For example, the predetermined route information module 820 may synchronize the information associated with one or more routes for the mobile device on a periodic schedule, e.g., during an overnight synchronization schedule when the mobile device is otherwise not is in use, is connected to a power source, etc. Accordingly, the predetermined route information module 820 may receive a message from a mobile device including information identifying a known route and, based on the route identifier, retrieve additional information associated with the route, e.g., average route length, average route travel time, etc.

The tracking area management module 825 may be configured to determine, select, or otherwise define a tracking area for the mobile device as it travels along the predetermined or known route. The tracking area may be defined for the mobile device based on the repeated mobility patterns of the mobile device as indicated by the historical information. For example, the tracking area management module 825 may define a tracking area that includes one or more tracking areas along the route, a tracking area that includes cells whose coverage area includes the route, etc. Accordingly, the network entity 405-c may define the tracking area for the mobile device to provide paging coverage without receiving location area update messages from the mobile device as it travels into new tracking areas along the known route.

In some aspects, the tracking area management module 825 may also consider additional information when defining the tracking area for the mobile device traveling along the known route. For example, the tracking area management module 825 may consider the start time for the mobile device traveling along the route, the average travel time along the route, etc. In some examples, the tracking area management module 825 may access additional information associated with various conditions along the known route, e.g., congestion, accidents, weather, etc., and define the tracking area for the mobile device based on the conditions.

In some aspects, the tracking area management module 825 may receive messages from the mobile device indicating that it has deviated from the known route, etc., and therefore rely on location area update reporting from the mobile device to define tracking areas.

The paging management module 830 may send a page to the mobile device via at least one cell of the defined tracking area along the known route. For instance, the paging management module 830 may receive a page for the mobile device via the backhaul/core network interface 840 and communicate with the tracking area management module 825 to determine which cell to send the page to. The paging management module 830 may send the page via the backhaul/core network interface 840 to at least the one cell included in the tracking area defined for the mobile device.

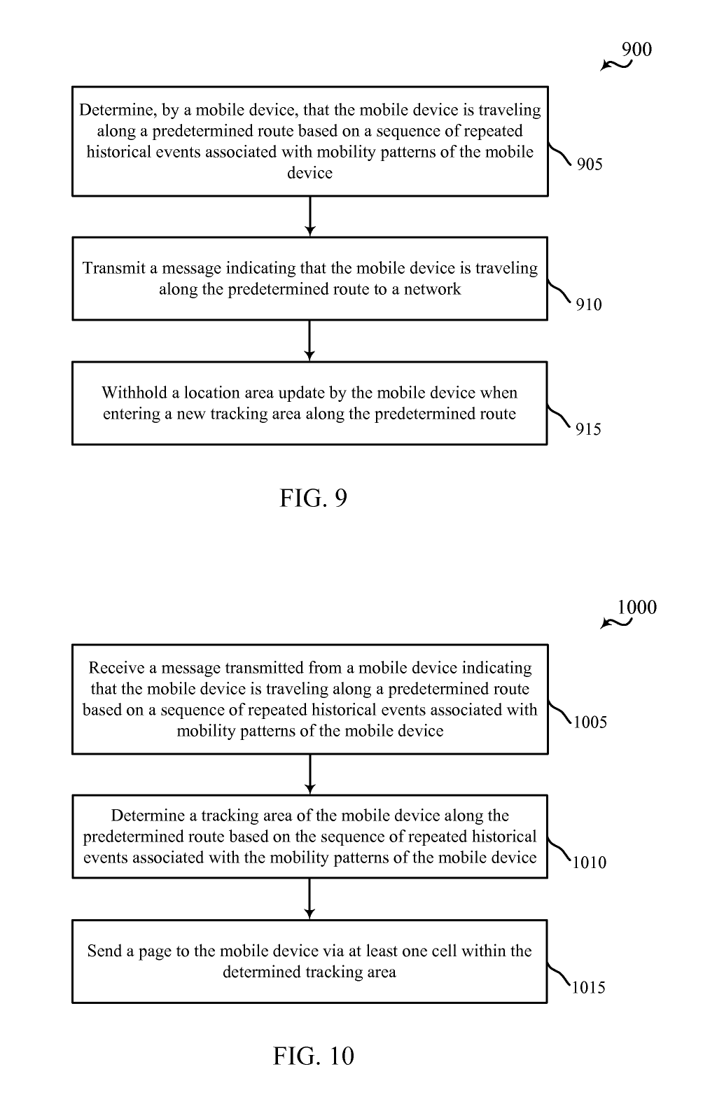

FIG. 9 is a flowchart illustrating an example of a method 900 for wireless communication, in accordance with various aspects of the present disclosure. For clarity, the method 900 is described below with reference to aspects of one or more of the mobile devices described with reference to FIGS. 1-8. In some examples, a mobile device may execute one or more sets of codes to control the functional elements of the mobile device to perform the functions described below. Additionally or alternatively, the mobile device may perform one or more of the functions described below using-purpose hardware.

At block 905, the method 900 may include the mobile device determining that it is traveling along a predetermined route. The mobile device may make this determination based on a sequence of repeated historical events associated with mobility patters of the mobile device. In certain aspects, the mobile device may determine that it has departed an origination location of the route within a given timeframe and is traveling along a particular path (e.g., highway, road, interstate, etc.). Accordingly, the current state or environmental events at the mobile device may trigger the initiation of the determination. The mobile device may make the determination that it is traveling along the predetermined or known route to within a predefined degree of confidence.

At block 910, the method 900 may include the mobile device transmitting a message to a network entity indicating that it is traveling along the predetermined route. The network entity may be a mobility management entity (MME) component of the core network in certain examples. The mobile device may indicate to the network that it is traveling along the predetermined route by transmitting an RRC connection request message that uses one or more information elements to convey the indication as well as to convey a route identifier, e.g., use a random value portion of the mobile device identity information element to convey the route identifier in combination with an establishment cause associated with traveling along a known route. In another example, the mobile device may use portions of a random access preamble message to convey the indication and pass the route identifier information. In some example, the mobile device may only pass the indication that it is traveling along the predetermined route and the network entity may determine which route based on a current location of the mobile device, e.g., based on which base station or cell that received the message from the mobile device.

At block 915, the method 900 may include the mobile device withholding a location area update message when entering a new tracking area along the predetermined route. For example, the mobile device may determine that it has sent the indication regarding it traveling along the predetermined route and, therefore, location area update reporting messages are not necessary while traveling along the known route.

The operation(s) at block 905, 910, or 915 may be performed using the historical information module 720, the predetermined route management module 725, and the location reporting module 730, respectively, described with reference to FIG. 7.

Thus, the method 900 may provide for wireless communication. It should be noted that the method 900 is just one implementation and that the operations of the method 900 may be rearranged or otherwise modified such that other implementations are possible.

FIG. 10 is a flowchart illustrating an example of a method 1000 for wireless communication, in accordance with various aspects of the present disclosure. For clarity, the method 1000 is described below with reference to aspects of one or more of the network entities described with reference to FIGS. 1-8. In some examples, a network entity may execute one or more sets of codes to control the functional elements of the network entity to perform the functions described below. Additionally or alternatively, the network entity may perform one or more of the functions described below using-purpose hardware.

At block 1005, the method 1000 may include the network entity receiving a message from a mobile device indicating that the mobile device is traveling along a predetermined route based on the sequence of repeated historical events associated with mobility patterns of the mobile device. As described above, the network entity may receive the indication message as a portion of an RRC message, as a portion of a RACH preamble message, etc. The network entity may access information associated with the predetermined route and, therefore, may know not to expect location area update messages from the mobile device as it travels through different tracking areas along the known route.

At block 1010, the method 1000 may include the network entity determining a tracking area for the mobile device along the predetermined route based on the sequence of repeated historical events associated with mobility patterns of the mobile device. For example, the network entity may access the historical information associated with the known route and determine which tracking areas cover the route. Accordingly, the network entity may define the tracking area for the mobile device that includes the tracking areas of the route. In another example, the network entity may define the tracking area to include one or more of the cells that provide coverage along the predetermined route. The network entity may define a tracking area that includes a rolling cell count based on where the mobile device is along the route, e.g., based on when the mobile device started along the route and how much time has passed.

At block 1015, the method 1000 may include the network entity sending a page to the mobile device via at least one cell within the determined tracking area. For example, the network entity may send the page to one cell within the tracking area, to a subset of cells within the tracking area, or to all cells within the tracking area. In certain aspects, the network entity may send the page to one cell and, if there is no response from the mobile device, send the page to additional cells to cover a larger area.

The operation(s) at block 1005, 1010, or 1015 may be performed using the predetermined route information module 820, the tracking area management module 825, and the paging management module 830, respectively, described with reference to FIG. 8.

Thus, the method 1000 may provide for wireless communication. It should be noted that the method 1000 is just one implementation and that the operations of the method 1000 may be rearranged or otherwise modified such that other implementations are possible.

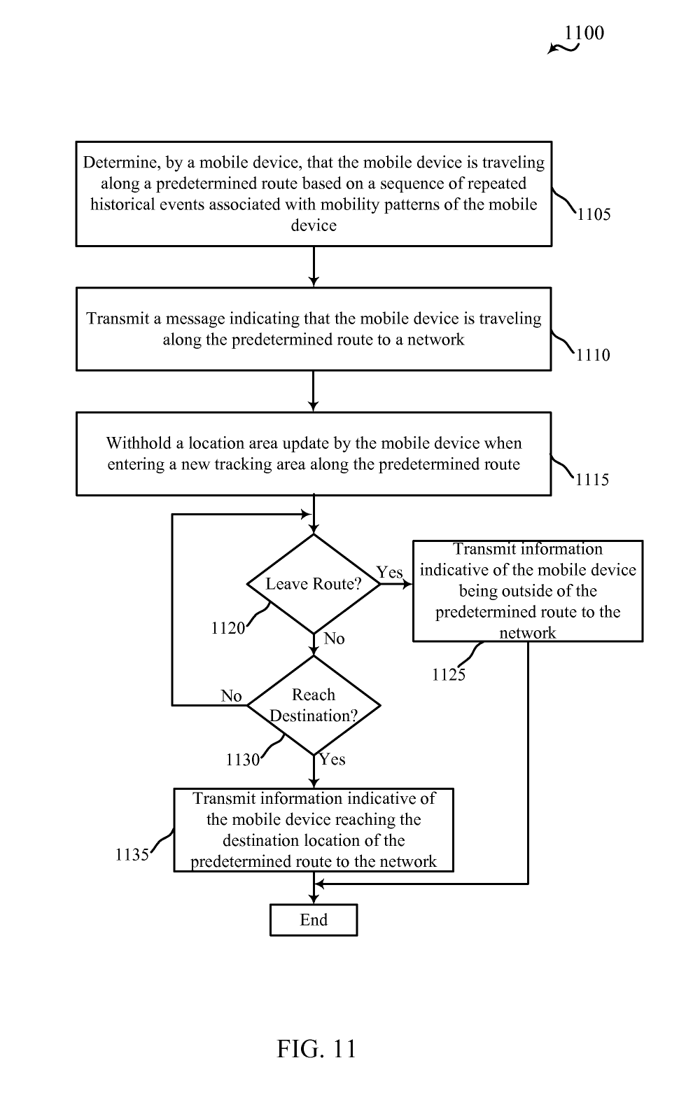

FIG. 11 is a flowchart illustrating an example of a method 1100 for wireless communication, in accordance with various aspects of the present disclosure. For clarity, the method 1100 is described below with reference to aspects of one or more of the mobile devices described with reference to FIGS. 1-8. In some examples, a mobile device may execute one or more sets of codes to control the functional elements of the mobile device to perform the functions described below. Additionally or alternatively, the mobile device may perform one or more of the functions described below using-purpose hardware.

At block 1105, the method 1100 may include the mobile device determining that it is traveling along a predetermined route. The mobile device may make this determination based on a sequence of repeated historical events associated with mobility patters of the mobile device. In certain aspects, the mobile device may determine that it has departed an origination location of the route within a given timeframe and is traveling along a particular path (e.g., highway, road, interstate, etc.). Accordingly, the current state or environmental events at the mobile device may trigger the initiation of the determination. The mobile device may make the determination that it is traveling along the predetermined or known route to within a predefined degree of confidence.

At block 1110, the method 1100 may include the mobile device transmitting a message to a network entity indicating that it is traveling along the predetermined route. The network entity may be a mobility management entity (MME) component of the core network in certain examples. The mobile device may indicate to the network that it is traveling along the predetermined route by transmitting an RRC connection request message that uses one or more information elements to convey the indication as well as to convey a route identifier, e.g., use a random value portion of the mobile device identity information element to convey the route identifier in combination with an establishment cause associated with traveling along a known route. In another example, the mobile device may use portions of a random access preamble message to convey the indication and pass the route identifier information. In some example, the mobile device may only pass the indication that it is traveling along the predetermined route and the network entity may determine which route based on a current location of the mobile device, e.g., based on which base station or cell that received the message from the mobile device.

At block 1115, the method 1100 may include the mobile device withholding a location area update message when entering a new tracking area along the predetermined route. For example, the mobile device may determine that it has sent the indication regarding it traveling along the predetermined route and, therefore, location area update reporting messages are not necessary while traveling along the known route.

At block 1120, the method 1100 may include the mobile device determining whether it has departed or deviated a predetermined distance from the known route. For example, the mobile device may determine that it has entered the coverage area of a base station or cell that is not located along the route. If the mobile device has left the route, at block 1125 the method 1100 may include the mobile device transmitting a message to the network entity indicating that it has traveled outside of the predetermined route. When the mobile device has deviated from the predetermined route and reported this to the network entity, it may resume normal location area update reporting to the network entity.

At block 1130, the method 1100 may include the mobile device determining if it has reached a destination location of the predetermined route. For example, the mobile device may determine that it has reached a work location, a home location, and the like, associated with the predetermined route. The mobile device may make this determination based on communicating with a known base station, cell, or access point (e.g., a home Wi-Fi, a work wireless network, etc.). If the mobile device determines that it has not reached the destination location, the method 1100 may include returning to block 1120 to continue to monitor for whether the mobile device has deviated from the predetermined route. If the mobile device determines that it has reached the destination location, at block 1135 the method 1100 may include the mobile device transmitting a message to the network entity indicating that it has reached the destination location of the predetermined route. Accordingly, the mobile device may determine that it has ended traveling along the predetermined route and, therefore, may revert to normal location area update reporting messages with the network entity.

The operation(s) at block 1105, 1110, 1115, 1120, 1125, 1130 or 1135 may be performed using at least one of the historical information module 720, the predetermined route management module 725, and/or the location reporting module 730 described with reference to FIG. 7.

Thus, the method 1100 may provide for wireless communication. It should be noted that the method 1100 is just one implementation and that the operations of the method 1100 may be rearranged or otherwise modified such that other implementations are possible.

In some examples, aspects from two or more of the methods 900-1100 may be combined. It should be noted that the methods 900, 1000], etc. are just example implementations, and that the operations of the methods 900-1100 may be rearranged or otherwise modified such that other implementations are possible.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for wireless communication, comprising:
determining, by a mobile device, that the mobile device is traveling along a predetermined route based on a sequence of repeated historical events associated with mobility patterns of the mobile device;
transmitting a message indicating that the mobile device is traveling along the predetermined route to a network; and
withholding a location area update by the mobile device when entering a new tracking area along the predetermined route.

2. The method of claim 1, further comprising:
transmitting information indicative of at least one of: a start time when the mobile device began traveling along the predetermined route, an average travel time associated with the mobile device traveling along the predetermined route, or a travel time deviation associated with the mobile device traveling along the predetermined route.

3. The method of claim 1, further comprising:
determining that the mobile device has traveled at least a predetermined distance outside of the predetermined route; and
transmitting information indicative of the mobile device being outside of the predetermined route to the network.

4. The method of claim 3, wherein determining that the mobile device is outside of the predetermined route comprises:
determining that the mobile device is in communication range with a cell in a tracking area other than tracking areas along the predetermined route.

5. The method of claim 1, further comprising:
determining that the mobile device has reached a destination location of the predetermined route; and
transmitting information indicative of the mobile device reaching the destination location of the predetermined route to the network.

6. The method of claim 5, further comprising:
transmitting information indicative of a travel time associated with the mobile device traveling along the predetermined route.

7. The method of claim 1, further comprising:
transmitting information indicative of one or more predetermined routes to the network.

8. The method of claim 7, further comprising:
transmitting, for each of the one or more predetermined routes, information indicative of at least one of an average travel time, a travel time deviation, an average start time, or an average arrival time.

9. The method of claim 1, further comprising:
receiving a page from a cell in at least one tracking areas along the predetermined route while the mobile device is traveling along the predetermined route.

10. An apparatus for wireless communication, comprising:
a processor; and
memory in electronic communication with the processor, the memory embodying instructions, the instructions executable by the processor to:
determine, by a mobile device, that the mobile device is traveling along a predetermined route based on a sequence of repeated historical events associated with mobility patterns of the mobile device;
transmit a message indicating that the mobile device is traveling along the predetermined route to a network; and
withhold a location area update by the mobile device when entering a new tracking area along the predetermined route.

11. The apparatus of claim 10, further comprising instructions executable by the processor to:
transmit information indicative of at least one of: a start time when the mobile device began traveling along the predetermined route, an average travel time associated with the mobile device traveling along the predetermined route, or a travel time deviation associated with the mobile device traveling along the predetermined route.

12. The apparatus of claim 10, further comprising instructions executable by the processor to:
determine that the mobile device has traveled at least a predetermined distance outside of the predetermined route; and
transmit information indicative of the mobile device being outside of the predetermined route to the network.

13. The apparatus of claim 12, wherein the instructions executable by the processor to determine that the mobile device is outside of the predetermined route are further executable to:
determine that the mobile device is in communication range with a cell in a tracking area other than tracking areas along the predetermined route.

14. The apparatus of claim 10, further comprising instructions executable by the processor to:
determine that the mobile device has reached a destination location of the predetermined route; and
transmit information indicative of the mobile device reaching the destination location of the predetermined route to the network.

15. The apparatus of claim 14, further comprising instructions executable by the processor to:
transmit information indicative of a travel time associated with the mobile device traveling along the predetermined route.

16. The apparatus of claim 10, further comprising instructions executable by the processor to:
transmit information indicative of one or more predetermined routes to the network.

17. The apparatus of claim 16, further comprising instructions executable by the processor to:
transmit, for each of the one or more predetermined routes, information indicative of at least one of an average travel time, a travel time deviation, an average start time, or an average arrival time.

18. The apparatus of claim 10, further comprising instructions executable by the processor to:
receive a page from a cell in at least one tracking areas along the predetermined route while the mobile device is traveling along the predetermined route.

19. A method for wireless communication, comprising:
receiving a message transmitted from a mobile device indicating that the mobile device is traveling along a predetermined route based on a sequence of repeated historical events associated with mobility patterns of the mobile device;
determining a tracking area of the mobile device along the predetermined route based on the sequence of repeated historical events associated with the mobility patterns of the mobile device; and
sending a page to the mobile device via at least one cell within the determined tracking area.

20. The method of claim 19, further comprising:
determining the tracking area without receiving a location area update message from the mobile device when the mobile device enters a new tracking area along the predetermined route.

21. The method of claim 19, further comprising:
receiving information from the mobile device associated with a start time of when the mobile device began traveling along the predetermined route; and
determining the tracking area based at least in part on the start time.

22. The method of claim 21, further comprising:
receiving information from the mobile device associated with an average travel time for the mobile device traveling along the predetermined route; and
determining the tracking area based at least in part on the start time and the average travel time.

23. The method of claim 21, further comprising:
accessing one or more information sources associated with travel conditions along the predetermined route; and
determining the tracking area based at least in part on the start time and the travel conditions.

24. The method of claim 23, wherein the travel conditions comprise at least one of a weather condition along the predetermined route, a traffic condition along the predetermined route, or an average travel time associated with beginning to travel along the predetermined route at the start time.

25. The method of claim 19, further comprising:
receiving information from the mobile device indicating that the mobile device has arrived at a destination location of the predetermined route.

26. An apparatus for wireless communication, comprising:
a processor; and
memory in electronic communication with the processor, the memory embodying instructions, the instructions executable by the processor to:
receive a message transmitted from a mobile device indicating that the mobile device is traveling along a predetermined route based on a sequence of repeated historical events associated with mobility patterns of the mobile device;
determine a tracking area of the mobile device along the predetermined route based on the sequence of repeated historical events associated with the mobility patterns of the mobile device; and
send a page to the mobile device via at least one cell within the determined tracking area.

27. The apparatus of claim 26, further comprising instructions executable by the processor to:
determine the tracking area without receiving a location area update message from the mobile device when the mobile device enters a new tracking area along the predetermined route.

28. The apparatus of claim 26, further comprising instructions executable by the processor to:
receive information from the mobile device associated with a start time of when the mobile device began traveling along the predetermined route; and
determine the tracking area based at least in part on the start time.

29. The apparatus of claim 28, further comprising instructions executable by the processor to:
receive information from the mobile device associated with an average travel time for the mobile device traveling along the predetermined route; and
determine the tracking area based at least in part on the start time and the average travel time.

30. The apparatus of claim 28, further comprising instructions executable by the processor to:
access one or more information sources associated with travel conditions along the predetermined route; and
determine the tracking area based at least in part on the start time and the travel conditions.
